(19) United States
(12) Patent Application Publication
(10) Pub. No.: US 2003/0018127 A1
(43) Pub. Date: Jan. 23, 2003

(54) Method for producing impact resistant plastics

(76) Inventors: Graham Edmund McKee, Neustadt (DE); Hermann Gausepohl, Mutterstadt (DE); Norbert Niessner, Friedelsheim (DE)

Correspondence Address: KEIL & WEINKAUF, 1350 CONNECTICUT AVENUE, N.W., WASHINGTON, DC, 20036, US

(21) Appl. No.: 10/182,147

(22) PCT Filed: Jan. 26, 2001
(86) PCT No.: PCT/EP01/00895

(30) Foreign Application Priority Data
Jan. 27, 2000 (DE) 100 03 508.6

(51) Int. Cl. C08G 63/48; C08G 63/91; C08L 31/02; C08L 51/00

(52) U.S. Cl. 525/70; 525/80

(57) ABSTRACT

The invention relates to a process for preparing an impact-modified plastic based on crosslinked rubber particles, where

(a) an aqueous dispersion or suspension of particles of a crosslinked rubber is produced from a first monomer mixture which has less than 50% by weight, preferably less than 5% by weight, in particular less than 2% by weight, content of conjugated diene compounds;

(b) where appropriate, the dispersion or suspension is precipitated, giving an aqueous rubber particle mixture with water content of at least 5% by weight;

(c) the dispersion or suspension of the rubber particles or the aqueous rubber particle mixture is added to a second mixture which comprises at least one other monomer, and

(d) the monomers of the second mixture are polymerized.

The invention further relates to a plastic obtainable by the process.

The invention relates to a process for preparing impact-modified plastics based on crosslinked rubber particles, and also to an impact-modified plastic obtainable by the process.

Impact-modified plastics have increased resistance to mechanical effects, making them particularly suitable for many applications, e.g. for consumer articles. These particular properties are achieved via the structure of these plastics, in which domains of elastomers, e.g. rubbers, have been embedded in a matrix made from thermoplastics. The multiphase nature of these impact-modified plastics, and therefore also the domain structure, is a result of their composition, made from a variety of polymeric components which are immiscible, or only partially miscible, with one another. Their impact strength comes from increased energy absorption during deformation as fracture is approached. The energy here is used to form microcavities or to bring about slippage of the matrix polymer chains. The multiphase nature is therefore a necessary precondition for the achievement of high impact strengths.

The following generally applies:

The two chemically different polymeric components usually form a dispersion which during processing shows only little phase separation and which does not tend to homogenize or form a macromolecular solution when subjected to extreme temperatures.

There has to be coupling between the elastomer particles and the matrix, i.e. the phase boundaries have to be capable of transmitting forces. The most effective coupling at the boundaries of the elastomer particles is achieved by graft copolymerization. The procedure here is generally that a copolymer is grafted onto a rubber by polymerization using a monomer mixture.

DE-A 29 10 168 discloses stable, flowable dispersions of rubbers in the form of discrete particles of median diameter from 100 to 3000 nm in organic liquids, in which the rubber present is from 1 to 20% by weight (based on the entire dispersion) of a crosslinked diene rubber, and from 0 to 20% by weight of water is also present in the form of a water-in-oil emulsion. Their continuous organic phase is from 99 to 66% by weight of C₁-C₁₀ alkyl acrylates or alkyl (meth)acrylates, methyl methacrylate, ethyl acrylate, or n-hexyl acrylate. As an alternative, their liquid phase may also be a mixture of from 85 to 50% by weight of styrene or α-methylstyrene and from 15 to 50% by weight of acrylonitrile, methacrylonitrile, or C₁-C₆-alkyl acrylates or alkyl (meth)acrylates, methyl methacrylate, ethyl acrylate, or n-hexyl acrylate. Another alternative proposed for the continuous organic phase is a mixture of from 85 to 50% by weight of C₁-C₁₀-alkyl acrylate or alkyl (meth)acrylate or from 15 to 50% by weight of acrylonitrile, methacrylonitrile, or styrene. Where appropriate, the continuous organic phase may comprise up to 60% by weight of admixed liquid hydrocarbon. The diene rubbers generally have strong crosslinking. They comprise at least 50% by weight, preferably more than 70% by weight, of gel. The rubbers are generally latices, aqueous rubber dispersions obtained by emulsion polymerization. Their rubbers are preferably homopolymers of conjugated dienes having from 4 to 8 carbon atoms, for example butadiene, isoprene, or chloroprene, or copolymers of these with up to 40% by weight, preferably up to 10% by weight, of a vinyl compound, such as acrylonitrile, methacrylonitrile, styrene, α-methylstyrene, halostyrenes, C₁-C₄-alkylstyrenes, C₁-C₄-alkylstyrenes, C₁-C₆-alkyl acrylates and C₁-C₆-alkyl methacrylates, acrylic acid, methacrylic acid, vinylsulfonic acid, allylsulfonic acid, alkylene glycol diacrylates and alkylene glycol dimethacrylates, and also diphenylbenzene. Aqueous emulsions of crosslinked rubbery diene polymers are dispersed in certain organic liquids so that the diene polymers become dispersed swollen particles. The water from the initial emulsion is likewise present in dispersed form as a water-in-oil emulsion in the organic liquid. If necessary, the water can be removed by selectively breaking the water-in-oil emulsion and separating off the water. However, for most applications of the organic rubber dispersions it is not necessary to separate off the water. However, it must be stably dispersed and must not separate out as a distinct phase.

DE-A 44 40 676 describes a process for preparing rubber molding compositions, and also rubber-modified molding compositions prepared by the process. Here, a first stage polymerizes a mixture which comprises an alkyl acrylate or alkyl methacrylate, a first monomer having two or more double bonds, and, where appropriate, one or more second monomers, to give a rubber, preferably using free radicals. A second stage dissolves or swells the resultant rubber in one or more third monomers, where appropriate with addition of a solvent, to form a second mixture. The rubber is either produced in anhydrous form or, for example if prepared by emulsion polymerization, is first dewatered and dried. A third stage polymerizes the second mixture formed after the dissolution or swelling process, to give the rubber-modified molding composition. Examples of first monomers are alkyl methacrylate, butanediol diacrylate, divinylbenzene, triallyl cyanurate, and dihydrodicyclopentadienyl acrylate, the latter being preferred. A disadvantage of the process of DE-A 4440676 is that if the rubber is prepared by emulsion polymerization it first has to be freed from the water. Appropriate operations are required for this, and make the process more time-consuming and more costly.

DE-A 24 00 659 describes a process for preparing rubber-modified resins. Here, an alkadiene rubber which has been grafted with monovinylidenearomatic monomers and with alkyl nitrile monomers is dispersed into a hot melt of a main copolymer composition of monovinylidenearomatic monomers and alkyl nitrile monomers. The grafting required for adequate force transmission between polymer matrix and rubber is therefore carried out in a separate step.

Because of the particular properties of impact-modified plastics and their wide application, and their resultant commercial importance, there is a constant requirement for new and improved plastics of this type. These should be simple to prepare, avoiding difficulties such as excessive viscosity increase of the reaction mixture during the preparation process or excessive restriction on batch size due to difficulties in dissipating the heat of reaction.

It is an object of the present invention, therefore, to provide a process for preparing impact-modified plastics, and also to provide an impact-modified plastic obtain-able by this process.

We have found that this object is achieved by means of a process for preparing an impact-modified plastic based on crosslinked rubber particles, where

(a) an aqueous dispersion or suspension of particles of a crosslinked rubber is produced from a first monomer mixture which has less than 50% by weight, preferably less than 5% by weight, in particular less than 2% by weight, content of conjugated diene compounds;

(b) where appropriate, the dispersion or suspension is precipitated, giving an aqueous rubber particle mixture with water content of at least 5% by weight;

(c) the dispersion or suspension of the rubber particles or the aqueous rubber particle mixture is added to a second mixture which comprises at least one other monomer, and

(d) the monomers of the second mixture are polymerized.

The first step (a) of the process produces a particulate rubber onto which another step (c) then grafts at least one other monomer. The skeleton of this resultant graft polymer is formed by the rubber, and the graft branches are formed from the at least one other monomer. Because the extent of grafting which takes place is not 100%, some of the rubber remains ungrafted and a chain polymer is at the same time formed from the at least one other polymer, the result being that there are three types of molecule in the molding composition. Since no drying of the rubber takes place prior to addition to the at least one other monomer, the preparation of the impact-modified plastic becomes simpler. The water is added together with the rubber particles to the second mixture which comprises at least one other monomer. There are various advantageous ways of utilizing the water introduced in this way into the reaction mixture. The water can prevent the rubber particles from swelling, can prevent a gel from forming and making the reaction mixture highly viscous. Instead, the condition of the reaction mixture remains that of a free flowing liquid. This means that pump circulation of the reaction mixture is easier, and that it can be stirred without difficulty during polymerization of the at least one other monomer, making it easier to dissipate the heat produced during the reaction. The water may also be used directly for cooling the reaction by evaporating the water during the polymerization. At the same time, this removes oxygen from the reaction system, permitting achievement of better color in the final product.

There are various ways of adding the rubber dispersion or the aqueous rubber particle mixture to the second mixture in step (c). The dispersion may be added directly to the mixture. However, if the second mixture comprises various monomers, it is also possible for one of the monomers to form an initial charge, and for the rubber suspension or the aqueous rubber particle mixture then to be added, and for the other monomers of the monomer mixture then to be introduced. This is advantageous if, for example, the other monomer of the second mixture is more volatile than water and the water is to be separated off prior to beginning the polymerization of the second mixture. In this case, a less volatile monomer of the second mixture forms an initial charge. The aqueous rubber dispersion is then introduced, and the water separated off, for example by distillation. The more volatile monomers may then be added so that the monomer mixture can be polymerized in step (d). It is, of course, also possible for some of the monomer mixture to form an initial charge, and then for the rubber dispersion to be added and, where appropriate after removal of the water, the remainder of the monomer mixture to be added.

The aqueous suspension of the rubber particles may be coagulated in step (b) to reduce water content. The water content of the resultant dispersion of the rubber particles is generally from 5 to 60% by weight. The advantages described cannot be achieved if the water content is less than 5% by weight.

The water content of the coagulated rubber suspension may be reduced to the desired water content with the aid of pressure, centrifugation, or drying. The coagulation of the rubber particles may also take place after addition of the rubber suspension to the second mixture. The polymerization of the at least one monomer of the second mixture may take place immediately after addition of the rubber dispersion. However, it is also possible for the rubber particles first to be swollen in the monomers of the second mixture, preferably for more than 5 minutes, and for the monomers of the second mixture then to be polymerized. Finally, a method for influencing the properties of the impact-modified plastic consists in firstly polymerizing to some extent the at least one monomer of the second mixture and adding the rubber dispersion only after some extent of polymerization has taken place. The remaining monomers of the second mixture are then polymerized with formation of a graft shell on the rubber particles. Another way of carrying out the reaction first polymerizes the monomers of the second mixture in bulk in the presence of the rubber particles. Water is added when the reaction is partially complete and then the reaction is completed in suspension. This is advantageous if the reaction mixture of a bulk polymerization becomes so viscous that the process cannot be controlled. There are no restrictions per se on the monomers which can be used for the second mixture, except that they have to be capable of free-radical polymerization.

Particularly good materials can be obtained if the second mixture comprises at least one monomer which has been selected from the group consisting of styrene, acrylonitrile, and methyl methacrylate.

It is advantageous for preparing the rubber particles if the first monomer mixture comprises at least one monomer which has been selected from the group consisting of ethylhexyl acrylate, butyl acrylate, dimethylsiloxane, ethylene, and α-olefins having from 3 to 20 carbon atoms.

In one particular embodiment of the process, the second mixture may also comprise at least one other polymer which is preferably compatible or partially compatible with the polymer obtained from the second monomer mixture. For the purposes of the present invention, compatibility means that no phase separation occurs between the at least one other polymer and the polymer obtained from the second mixture. An example of a way of producing the other polymer is to polymerize the second monomer mixture to some extent, then add the rubber dispersion to the partially polymerized monomer mixture, and then complete the polymerization of the second mixture.

The glass transition temperature T_{g} of the other polymer is preferably above 0° C., with preference above 20° C., particularly preferably above 50° C.

The glass transition temperature of the rubber is preferably below 0° C., with preference below −10° C., particularly preferably below −20° C., glass transition temperature being determined by SDC to ASTM 3418. This gives the rubber its required softness. The glass transition temperature here may be adjusted either by using an acrylate or methacrylate whose polymer has the desired glass transition temperature, or by using a mixture of acrylate or of methacrylates which have various side-chain lengths. This adjustment of glass transition temperature is based on the fact that the glass transition temperature of acrylate and methacrylate polymers initially falls away as side-chain length increases, then passes through a minimum before rising again. The minimum is at a side chain of about 7 carbon atoms for polyacrylates and for 10 for polymethacrylates. The rubber particles may have a hard core made from a copolymer which preferably has a glass transition temperature above 0° C., particularly preferably above 10C, in particular above 20° C. This hard core may be composed of polystyrene, for example.

The refractive index of the hard core is preferably above 1.53, with preference above 1.56, in particular above 1.57. Impact-modified plastics which comprise small rubber particles are mostly opaque and hence difficult to color. The hard core can be used to harmonize the refractive index of the rubber particles to the surrounding polymer matrix, reducing the scattering of light. This equalization is particularly effectively achieved using a hard core which contains styrene or contains a styrene derivative. These polymers exhibit a particularly high refractive index.

The size of the rubber particles in the polymer matrix is preferably less than 10 μm, with preference less than 5 μm, in particular less than 4 μm. The particle size here is based on the size of the rubber particles in the final product.

The swelling index of the rubber particles is preferably from 2 to 100, with preference from 3 to 70, in particular from 5 to 60. The swelling index here is determined in the following way. A film is cast using the dispersion of the grafted crosslinked rubber particles, and the water is evaporated at 23° C. The film is then dried at 50° C. and subatmospheric pressure. About 0.5 g of the film is swollen for 24 hours in a solvent, such as tetrahydrofuran or dimethylformamide. The polymer gel is then separated by centrifugation from the solvent not bound into the gel. The gel is weighed, then dried and reweighed. The swelling index (SI) is calculated in accordance with the following equation:

$$SI = \frac{weight of swollen polymer gel}{weight of driedpolymer gel}$$

Based on the weight of the second monomer mixture, up to 80% by weight, preferably up to 60% by weight, in particular up to 20% by weight, of a solvent may be added to the second mixture. Examples of suitable solvents are toluene, ethylbenzene, dimethylformamide, acetone, etc. However, the polymerization of the second mixture particularly advantageously takes place with no solvent present. Addition of solvent is advantageous if the viscosity of the second mixture rises too sharply during the polymerization.

For certain applications it can be advantageous for the second mixture to comprise a protective colloid. Polyvinyl alcohols are examples of a suitable protective colloid.

The impact-modified plastics obtainable by the process of the invention exhibit very advantageous properties. The invention therefore also provides an impact-modified plastic obtainable by the process of the invention.

The impact-modified plastic obtainable by the process of the invention may also be present in a mixture with at least one other synthetic polymer. Suitable other synthetic polymers are polycarbonates, polyesters, polyamides, polyalkyl acrylates, including homo- and copolymers, and also the high-temperature-resistant poly(ether) sulfones. Other suitable polymers are polypropylene, polyethylene, polytetrafluoroethylene (PTFE), and polystyrene-acrylonitrile. Preference is given to polyphenylene ethers (PPE), syndiotactic polystyrene, styrene-diphenylethylene copolymers, and also copolymers with styrene content above 85% by weight, if the polymer prepared from the second monomer mixture contains more than 85% by weight of styrene. If the polymer prepared by polymerizing the second monomer mixture contains more than 15% by weight of acrylonitrile and/or methyl meth-acrylate, preference is given to polycarbonates, polyesters, polyamides, and copolymers made from acrylonitrile and/or methyl methacrylate.

The impact-modified plastics may also comprise, besides the components described, additives such as lubricants, mold-release agents, pigments, dyes, flame retardants, antioxidants, light stabilizers, fibrous or pulverulent fillers, fibrous or pulverulent reinforcing agents, and also antistats, the amounts being those usual for these agents.

Examples are used to give further illustration of the invention. The compounds used in the examples are as follows:

Styrene, acrylonitrile, butyl acrylate, and dihydrodicyclopentadienyl acrylate were purchased from BASF AG and used with no further purification.

tert-Dodecyl mercaptan was purchased from Bayer AG;

benzoyl peroxide was purchased from Akzo Nobel Chemicals GmbH;

Moviol® 8-88 is a polyvinyl alcohol whose degree of hydrolysis is 88 mol % and whose viscosity as a 4% strength solution in water at 20° C. is 8 mPa/s, measured to DIN 53015, and is marketed by the company previously known as Hoechst AG.

Moviol® 4-88 is identical with Moviol® 8-88 except that the viscosity of a 4% strength solution in water at 20° C. is 4 mPa/s.

The emulsifier K30 is the sodium salt of a C₁₂-C₁₆ paraffinsulfonic acid and is marketed by Bayer AG.

Luviskol® K90 is a product of BASF AG and is a polyvinylpyrrolidone with K value 90, measured from a 1% strength solution in water at 25° C. K value measurement is described in Cellulose Chemie, 13, 1932, pp. 358-364.

Tetrasodium diphosphate was purchased from Merck KGAA.

Ertivinol® 3092 is a polyvinyl alcohol from the company Ercos.

### EXAMPLE 1

(a) Rubber Preparation

A polybutyl acrylate-dihydrodicyclopentadienyl acrylate dispersion (98:2) was prepared by emulsion polymerization. To prepare a seed latex, 16 g of butyl acrylate and 0.4 g of tricyclodecenyl acrylate were heated to 60° C. in 150 g of water with addition of 1 g of the sodium salt of a C12-C18 paraffinsulfonic acid, 0.3 g of potassium persulfate, 0.3 g of sodium hydrogencarbonate, and 0.15 g of sodium pyrophosphate, with stirring. 10 minutes after the polymerization reaction initiated, a mixture made from 82 g of butyl acrylate and 1.6 g of tricyclodecenyl acrylate was added within a period of 3 hours. Once monomer addition had ended, the reaction was allowed to continue for a further hour.

Solids content was 41.1% and particle size was 0.080 mm (monodisperse).

(b) Preparation of Rubber-Modified Polystyrene-Acrylonitrile

199.5 g of the rubber dispersion obtained under (a) were charged to a 2 liter round-bottomed flask, and 690 g of styrene, 230 g of acrylonitrile, 1.0 g of tert-dodecyl mercaptan, 1.33 g of benzoyl peroxide, and 75 g of a 10% strength solution of Moviol® 4-88 in water were then added. The mixture was stirred for 3 minutes at 7500 rpm using an Ultra-Turax® stirrer and then transferred to a 6 liter steel tank equipped with a stirrer and a thermometer, acting as baffle. The reaction mixture was heated to 86° C. under nitrogen, with stirring at 150 rpm. After 20 minutes at 86° C. conversion of 14.1% had been achieved. 0.92 g of dicumyl peroxide, 15.2 g of Luviskol® K90, 6.09 g of Ertivinol® 30/93, and 2.03 g of Na₄P₂O₇ in 2030 g of water were then added. The mixture was converted into a suspension by increasing the stirrer speed to 350 rpm. The polymerization of the batch was completed as follows:

3 hours at 110° C.

3 hours at 130° C.

6 hours at 140° C.

The reaction mixture was cooled and the solids content was isolated by filtration over Calico®. The polymer was dried at 80° C. at subatmospheric pressure. Small standard bar specimens were produced from the dried material at a melt temperature of 240° C. by injection molding.

### EXAMPLE 2

(a) Rubber Preparation

An emulsion was prepared in a Dispermat® (VMA-Getzmann GmbH D-51580 Reichshof, Germany) by stirring the following mixture for 20 minutes at 7000 rpm:

1345.1 g of water

196.0 g of a 10% strength Moviol® 8-88 (PVA) solution in water

9680.4 g of n-butyl acrylate

19.6 g of dihydrodicyclopentadienyl acrylate

4.9 g of dilauryl peroxide

9.8 g of a 40% strength solution of emulsifier K30 in water.

50 g of the emulsion were charged to a glass flask under nitrogen and polymerization was started at 67° C. for a period of 5 minutes. The rest of the emulsion was then metered in over a period of 90 minutes. Polymerization of the batch was completed in a period of a further 90 minutes. This gave a dispersion with solids content of 38.5%. Particle size was determined by Fraunhofer laser diffraction.

D (10)=0.28 m

D (50)=0.58 m

D (90)=1.17 m

(b) Preparation of Rubber-Modified Polystyrene-Acrylonitrile

207.8 g of the dispersion obtained in 2(a) formed an initial charge in a 2 liter round-bottomed flask, and 690 g of styrene, 230 g of acrylonitrile, and 1.5 g of tert-dodecyl mercaptan were then added. The mixture was stirred for 3 minutes at 7500 rpm using an Ultra-Turax® stirrer and then transferred to a 6 liter steel tank equipped with a stirrer and a thermometer, acting as baffle. The mixture was heated to 123° C. under nitrogen, with stirring (150 rpm). After 20 minutes 0.92 g of dicumyl peroxide and a solution of 15.2 g of Luviskol® K90, 6.09 g of Ertivinol® 30/93, and 2.03 g of Na₄P₂O₇ in 2030 g of water were added, and the mixture was converted into a suspension by increasing the stirrer speed (to 350 rpm).

The polymerization of the batch was completed as follows:

3 hours at 110° C.

3 hours at 130° C.

6 hours at 140° C.

The reaction mixture was cooled and the solids content was isolated by filtration over Calico® and dried at 80° C. at subatmospheric pressure. Small standard bar specimens were produced from the dried polymer material at a melt temperature of 240° C. by injection molding with a mold temperature of 60° C.

### EXAMPLE 3

(a) Preparation of Rubber Dispersion

Preparation of the rubber dispersion was based on Example 2(a).

(b) Preparation of Rubber-Modified Polystyrene-Acrylonitrile

Using a method based on Example 2(b), 690 g of styrene, 230 g of acrylonitrile, and 1.5 g of tert-dodecyl mercaptan were added to 207.8 g of the rubber dispersion. The mixture was allowed to swell for 3 hours at room temperature, and then 1.3 g of benzoyl peroxide and 1.33 g of tert-butyl perpivalate were added. The reaction mixture was transferred to a 6 liter steel tank and, as in Example 2(b), a solution of 15.2 g of Luviskol® K90, 6.09 g of Ertivinol® 30/93, and 2.03 g of Na₄P₂O₇ in 2030 g of water was added. The mixture was converted into a suspension by increasing the stirrer speed and polymerized at 60° C. After 2 hours, a further 1.23 g of tert-butyl perpivalate was added, and polymerization of the reaction mixture was completed for 12 hours at 60° C. and for 5 further hours at 86° C. The work-up of the reaction mixture was based on Example 2(b).

### EXAMPLE 4

(a) Preparation of Rubber Dispersion

Preparation of the rubber dispersion was based on Example 2(a).

(b) Preparation of Rubber-Modified Polystyrene-Acrylonitrile

690 g of styrene and 1.5 g of tert-dodecyl mercaptan were added to 207.8 g of the rubber dispersion, and the mixture was allowed to swell for 20 hours. The content of free styrene, i.e. the amount not bound within the rubber, was determined as 54%. 124.2 g of acrylonitrile (corresponding to a ratio of free styrene to acrylonitrile of 75:25) and 1.33 g of benzoyl peroxide were added to the reaction mixture. The mixture was transferred to a 6 liter steel tank equipped with a stirrer and a thermometer which acted as a baffle, and heated to 86° C. under nitrogen. The conversion achieved after 30 minutes was 23.4%. 0.81 g of dicumyl peroxide and, as in Example 2(b), a solution of 15.2 of Luviskol® K90, 6.09 g of Ertivinol® 30/93, and 2.03 g of NA₄P₂O₇ in 2030 g of water was added. Completion of the polymerization of the reaction mixture, and its work-up, were based on Example 2(b).

### EXAMPLE 5

(a) Preparation of Rubber Dispersion

The rubber dispersion was prepared by a method based on Example 2(a), but no emulsifier K 30 was added. The solids content of the dispersion was 38.8%. The median particle size (D 50) was determined as 1.21 μm by Fraunhofer laser diffraction.

(b) Preparation of Rubber-Modified Polystyrene-Acrylonitrile

216.5 g of the rubber dispersion obtained in 5(a), 724.5 g of styrene, and 241.5 g of acrylonitrile, 1.4 g of tert-butyl perpivalate, and 1.05 g of tert-dodecyl mercaptan were placed in a 6 liter steel tank equipped with a stirrer and a thermometer, which acted as baffle, and the rubber was allowed to swell for 24 hours under 3 bar of nitrogen pressure. The mixture was then heated to 60° C. and stirred under nitrogen (150 rpm). The conversion achieved after 180 minutes was 22.2%, and the reaction mixture was then converted into a suspension by increasing the stirrer speed and adding 0.97 g of dicumyl peroxide and a solution of 19.5 g of Luviskol® K90, 5.85 g of Ertivinol® 30/93, and 1.95 g of Na₄P₂O₇ in 1950 g of water. Polymerization of the mixture was completed at 60° C. for a period of 15 hours and then at 120° C. for a further 5 hours. The reaction mixture was cooled, and the solids content was isolated by filtration over Calico® and dried at 80° C. at subatmospheric pressure. Small standard bar specimens were produced from the dried polymer material at a melt temperature of 240° C. and a mold temperature of 60° C. by injection molding.

### EXAMPLE 6

### Comparison

Example 5 was repeated but there was no admixture of rubber dispersion.

Testing of Products

The hole notch impact strength to DIN 53753-L-3.0, issue of 4/81, the impact strength to DIN 53453-n, issue of 5/75, and the notch impact strength to DIN 53453-K, issue of 5/75 were measured on the standard small bar specimens obtained in Examples 1 to 6.

Melt flowability in ml/10 minutes was measured at 200° C. and 21.6 kg to DIN 53735. The results of testing are given in Table 1.

TABLE 1
Physical properties of impact-modified plastics

| | | | Hole notch | Melt |
|---|---|---|---|---|
| | Impact | Notch impact | impact | flowability |
| | strength | strength | strength | ml/10 min, |
| Example | kJ/m² at 23° C. | kJ/m² at 23° C. | kJ/m² at 23° C. | 200° C./5 kg |
| 1 | 40 | 5 | 11 | 3 |
| 2 | 52 | 6 | | 15 |
| 3 | 46 | 7 | 13 | 2 |
| 4 | 50 | 6 | 14 | 13 |
| 5 | 47 | 6 | 11 | — |
| 6 | 6 | 2.5 | 13 | — |
| Comparison | | | | |

We claim:

1. A process for preparing an impact-modified plastic based on crosslinked rubber particles, where
(a) an aqueous dispersion or suspension of particles of a crosslinked rubber is produced from a first monomer mixture which has less than 50% by weight, preferably less than 5% by weight, in particular less than 2% by weight, content of conjugated diene compounds;
(b) where appropriate, the dispersion or suspension is precipitated, giving an aqueous rubber particle mixture with water content of at least 5% by weight;
(c) the dispersion or suspension of the rubber particles or the aqueous rubber particle mixture is added to a second mixture which comprises at least one other monomer, and
(d) the monomers of the second mixture are polymerized.

2. A process as claimed in claim 1, where the second mixture comprises at least one monomer which has been selected from the group consisting of styrene, acrylonitrile, and methyl methacrylate.

3. A process as claimed in claim 1 or 2, where the first monomer mixture comprises at least one monomer which has been selected from the group consisting of ethylhexyl acrylate, butyl acrylate, dimethylsiloxane, ethylene, and α-olefins having from 3 to 20 carbon atoms.

4. A process as claimed in any of claims 1 to 3, where the second mixture comprises at least one other polymer which is preferably compatible or partially compatible with the polymer obtained from the second mixture.

5. A process as claimed in any of claims 1 to 4, where the rubber particles have a hard core made from a copolymer which preferably has a glass transition temperature above 0° C., in particular above 10° C., particularly preferably above 20° C.

6. A process as claimed in any of claims 1 to 5, where the size of the rubber particles is less than 10 μm, preferably less than 5 μm, in particular less than 4 μm.

7. A process as claimed in any of claims 1 to 6, where, based on the weight of the second mixture, up to 80% by weight, preferably up to 60% by weight, in particular up to 20% by weight, of a solvent has been added in the second mixture.

8. A process as claimed in any of claims 1 to 7, where the second mixture comprises a protective colloid.

9. An impact-modified plastic based on crosslinked rubber particles, obtainable by a process as claimed in any of claims 1 to 8.
